(19) United States
(12) Patent Application Publication
(10) Pub. No.: US 2026/0045151 A1
(43) Pub. Date: Feb. 12, 2026

(54) LOTTERY TICKET VENDING MACHINE WITH LOCAL MAINTENANCE ACCESS

(71) Applicant: Brightstar Global Solutions Corporation, Providence, RI (US)

(72) Inventor: Medina Marie Topalian, East Greenwich, RI (US)

(21) Appl. No.: 18/796,882

(22) Filed: Aug. 7, 2024

(51) Int. Cl. G07F 17/42; G07F 9/00

(52) U.S. Cl. CPC G07F 17/42; G07F 9/006

(57) ABSTRACT

Lottery ticket vending machines configured to enable a purchaser to select one or more different instant lottery tickets to purchase via one or more purchaser input devices, dispense the instant lottery tickets, enable local maintenance access via the one or more purchaser input devices.

### BACKGROUND

The present disclosure relates to lottery ticket vending machines.

Lottery tickets such as instant lottery tickets may be printed on a strip that may be rolled or fan-folded and provided as a pack of lottery tickets. Lottery tickets in such strips may be separated along perforations formed between adjacent tickets in the strips. Lottery tickets may vary in width and length. Lottery tickets may be sold from such packs using lottery ticket vending machines. A lottery ticket vending machine may include multiple ticket drawers that hold the lottery tickets and a movable ticket burster that moves to a particular ticket drawer to dispense a purchased lottery ticket.

### BRIEF SUMMARY

In various embodiments, the present disclosure relates to a lottery ticket vending machine including: a housing; a ticket drawer holder in the housing, the ticket drawer holder including a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; a code reader supported by the housing, the code reader configured to receive an input code; a display device supported by the housing; and a controller including a processor and memory device. The memory device stores a plurality of instructions, which when executed by the processor cause the processor to: cause the code reader to receive an input code; receive code data that is based on the input code received by the code reader; authenticate the code data as a maintenance access code; and responsive to authentication of the code data, cause a display by the display device of a vending machine maintenance user interface.

In various other embodiments, the present disclosure relates to a lottery ticket vending machine including: a housing; a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; a code reader supported by the housing, the code reader configured to receive an input code; a display device supported by the housing; and a controller including a processor and memory device. The memory device stores a plurality of instructions, which when executed by the processor cause the processor to: cause the code reader to receive an input code displayed by a display device of a field maintenance user device, wherein the input code includes a changeable code; receive code data that is based on the input code received by the code reader; authenticate the code data as a maintenance access code; and responsive to authentication of the code data, cause a display by the display device of a vending machine maintenance user interface.

In various other embodiments, the present disclosure relates to a lottery ticket vending machine including: a housing; a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; a code reader supported by the housing, the code reader configured to receive an input code; a display device supported by the housing; and a controller including a processor and memory device. The memory device stores a plurality of instructions, which when executed by the processor cause the processor to: cause the code reader to receive an input code; receive code data that is based on the input code received by the code reader; authenticate the code data as a maintenance access code based on a local maintenance access authorization message received from a central lottery server; and responsive to authentication of the code data, cause a display by the display device of a vending machine maintenance user interface.

Additional features are described in, and will be apparent from, the following Detailed Description and the figures.

### BRIEF DESCRIPTION OF THE SEVERAL VIEWS OF THE DRAWINGS

FIG. 1 is a front perspective view of a lottery ticket vending machine of one example embodiment of the present disclosure shown with a front door thereof in a closed position.

FIG. 2 is a front perspective view of the lottery ticket vending machine of FIG. 1 shown with the front door thereof in an open position, shown with a left side wall panel thereof removed, showing three ticket drawer holders and three movable ticket bursters respectively associated with the three ticket drawer holders, and showing a ticket collection receptacle of the front door.

FIG. 3 is a front view of the lottery ticket vending machine of FIG. 1 shown with the front door thereof in the open position, shown with the left side wall panel thereof removed, showing the three ticket drawer holders and the three movable ticket bursters respectively associated the three ticket drawer holders, and showing the ticket collection receptacle of the front door.

FIG. 4 is an enlarged fragmentary perspective view of one of the ticket drawer holders and the ticket burster associated with that ticket drawer holder of the lottery ticket vending machine of FIG. 1 shown removed from the lottery ticket vending machine.

FIG. 5 is an enlarged fragmentary perspective view of the ticket drawer holder and the ticket burster of FIG. 4.

FIG. 6 is another enlarged fragmentary perspective view of the ticket drawer holder and the ticket burster of FIG. 4.

FIG. 7 is an enlarged fragmentary side view of the ticket drawer holder and the ticket burster of FIG. 4.

FIG. 8 is a block diagram of a system for providing a local maintenance access feature to a lottery ticket vending machine in accordance with one example embodiment of the present disclosure, and wherein the system includes the lottery ticket vending machine of FIG. 1, a field maintenance user device, and a central lottery server.

FIG. 9 is a flow chart of an example process for providing a local maintenance access feature of the lottery ticket vending machine of FIG. 1.

FIG. 10 is a block diagram of a system for providing a local maintenance access feature to a lottery ticket vending machine according to an alternative embodiment of the present disclosure, and wherein the system includes the lottery ticket vending machine of FIG. 1, the central lottery server of FIG. 8, and a technician identification card.

### DETAILED DESCRIPTION

In various embodiments, the present disclosure relates to a lottery ticket vending machine that includes purchaser input devices, a code reader, one or more ticket bursters, and a plurality of ticket drawers.

In various embodiments, the lottery ticket vending machine is configured to: (1) enable a purchaser to select one or more different instant lottery tickets to purchase via the purchaser input device(s); (2) responsive to each user selected and purchased instant lottery ticket, cause a burster of the instant lottery ticket to obtain and dispense that instant lottery ticket; and (3) enable a local maintenance access feature via the purchaser input devices.

In various embodiments, the lottery ticket vending machine is configured to: (1) cause the code reader to receive an input code; (2) authenticate the input code as a maintenance access code; and (3) responsive to authentication of the input code, cause a display of a vending machine maintenance user interface by the purchaser input devices.

In various embodiments, the lottery ticket vending machine is also configured to: (1) enable a user to select one or more different draw lottery tickets to purchase via the user input device(s); and (2) responsive to each user selected and purchased draw lottery ticket, cause a printer of the lottery ticket vending machine to print and enable the dispensing of the draw lottery ticket.

In various embodiments, the present disclosure also provides a system for enabling a local maintenance access feature of a lottery ticket vending machine. In various embodiments, the system includes a lottery ticket vending machine and a field maintenance user device. The system is configured to: (1) display a maintenance access code on a display device of the field maintenance user device; (2) cause the code reader of the lottery ticket vending machine to receive the displayed maintenance access code; (3) authenticate the displayed maintenance access code as an authorized code; and (4) responsive to authentication of the displayed maintenance access code, cause a display of a vending machine maintenance user interface by the purchaser input devices. In certain scenarios, the field maintenance user device is operable by a field technician for the lottery ticket vending machine to gain secure access to the vending machine maintenance user interface.

In various embodiments, the present disclosure provides a system for enabling a local maintenance access feature of a lottery ticket vending machine. In various embodiments, the system includes a lottery ticket vending machine, a field maintenance user device, and a central lottery server. The lottery ticket vending machine includes purchaser input devices, a code reader, one or more ticket bursters, and a plurality of ticket drawers. The system is configured to: (1) display a maintenance access code on a display device of the field maintenance user device; (2) cause the code reader of the lottery ticket vending machine to receive the displayed maintenance access code; (3) authenticate the displayed maintenance access code as an authorized code based on a local maintenance access authorization message received from a central lottery server; and (4) responsive to authentication of the displayed maintenance access code, cause a display of a vending machine maintenance user interface by the purchaser input devices. In certain scenarios, the field maintenance user device is operable by a field technician for the lottery ticket vending machine to gain secure access to the vending machine maintenance user interface.

In various embodiments, the present disclosure also provides a system for enabling a local maintenance access feature of a lottery ticket vending machine. In various embodiments, the system includes a lottery ticket vending machine and a technician identification card. The lottery ticket vending machine includes purchaser input devices, a code reader, one or more ticket bursters, and a plurality of ticket drawers. The technician identification card includes a maintenance access code as a printed code on the technician identification card. The lottery ticket vending machine is configured to: (1) cause the code reader to scan the printed code; (2) authenticate the printed code as an authorized code; and (3) responsive to authentication of the printed code, cause a display of a vending machine maintenance user interface by the purchaser input devices.

For a better understanding of the present disclosure, example instant lottery tickets are first generally described herein.

Various known instant lottery tickets are single game instant lottery tickets. An example single game instant lottery ticket can include: (1) a ticket substrate having a front surface and a back surface; (2) a predefined scratch-off area on the front surface; (3) variable lottery game indicia printed on the predefined scratch-off area; (4) a scratch-off coating (“SOC”) covering the variable lottery game indicia and the predefined scratch-off area; and (5) variable instant lottery ticket information indicia printed on the back surface. The instant lottery ticket information indicia can include text, one or more ticket numbers, one or more ticket barcodes, and other instant lottery ticket information that is in human readable and machine readable forms. Certain of this instant lottery ticket information: (a) identifies the instant lottery ticket; (b) the set, run, and/or pack of instant lottery tickets that the instant lottery ticket is part of; and (c) other inventory control information.

Various lottery tickets are often arranged after manufacture (which includes after complete printing) in lottery ticket packs for storage, organization, sorting, picking, shipping to lottery ticket distributors or ticket retailers, and validation. Instant lottery ticket packs can include a plurality of lottery tickets (that are all of the same type, same size, and for the same game(s), and can be protected for storage and shipping by a transparent pack wrapping, such as transparent plastic wrapping, securely wrapped around the plurality of lottery tickets. A pack of lottery tickets can include all of the lottery tickets attached to each other but joined by perforations. Such lottery tickets of a pack can be detached from each other along such perforations. While lottery tickets of each pack are often manufactured in a continuous strip that is fan-folded for convenient supply, the packs can be in other forms such as in a roll form. These packs in the fan-folded form or in the roll form are configured to be dispensed via a lottery ticket vending machine.

Lottery ticket vending machines can include various components such as but not limited to pinch rollers, stepper motors, and cutting blades to separate and dispense lottery tickets from a pack of lottery tickets, for example, within one or more ticket bursters. When a user purchases an instant lottery ticket, the ticket burster associated with a ticket drawer holding that purchased ticket moves into a ticket receipt position aligned with that ticket drawer to receive and dispense the purchased ticket.

Various embodiments of the present disclosure provide a lottery ticket vending machine that provides a local maintenance access feature for facilitating maintenance of the lottery ticket vending machine.

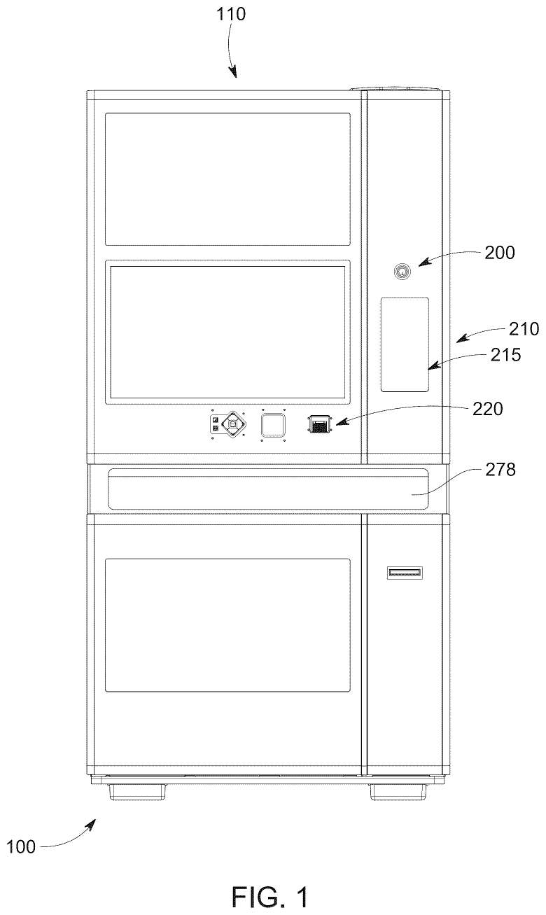

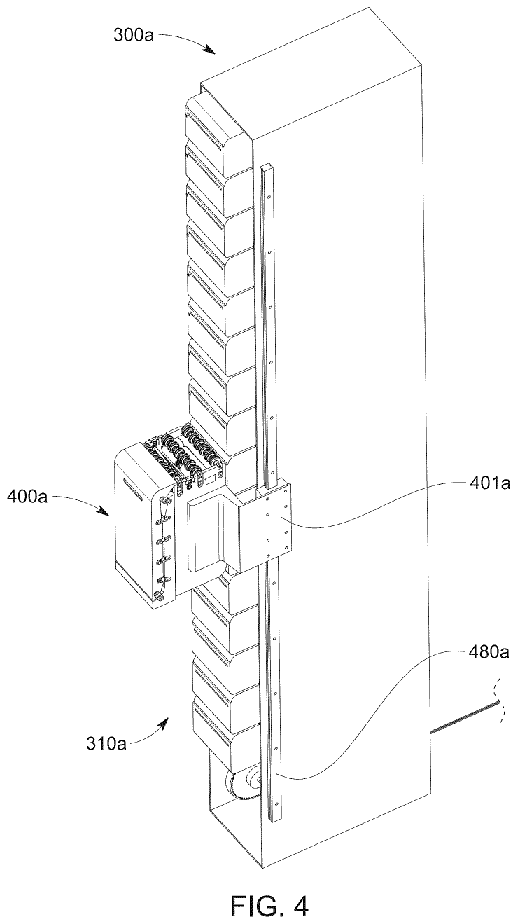

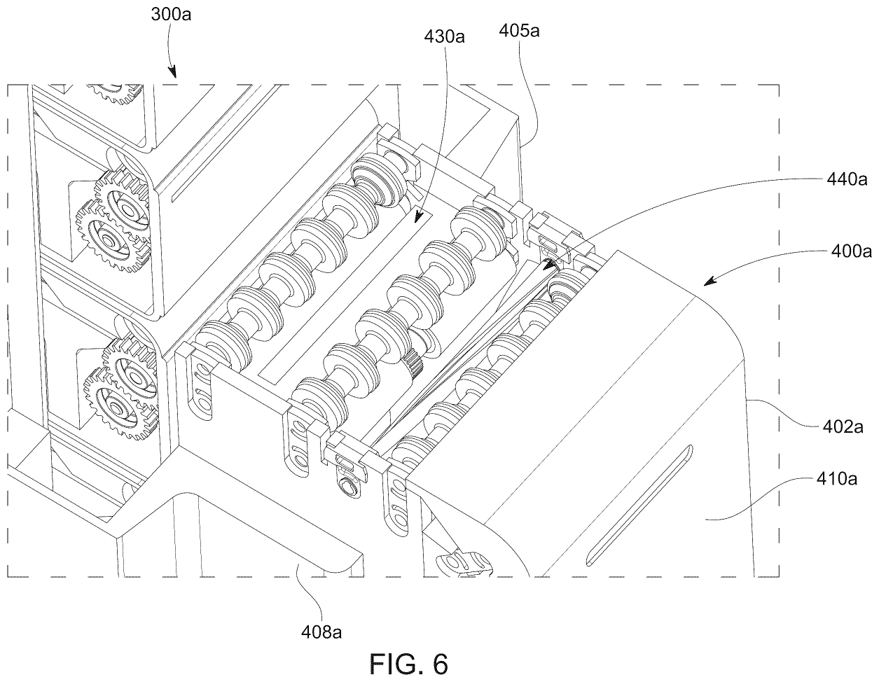

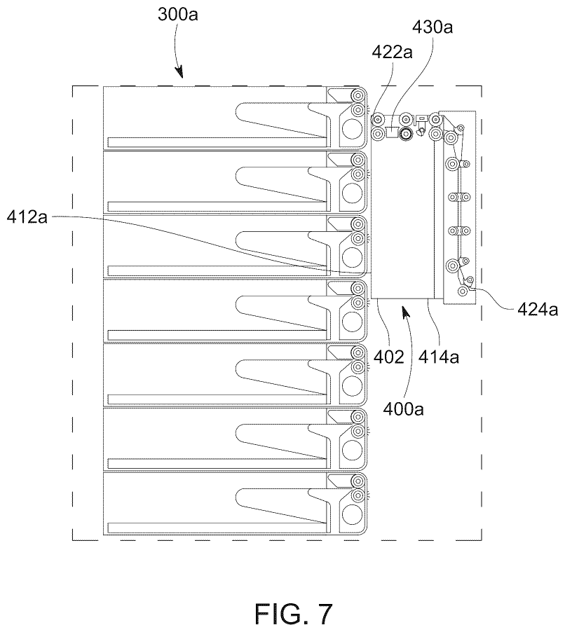

Turning now to FIGS. 1, 2, 3, 4, 5, 6, and 7, a lottery ticket vending machine of one example embodiment of the present disclosure is generally illustrated and indicated by numeral 100. The lottery ticket vending machine 100 may be referred to herein as the “ticket vending machine” or the “vending machine” for brevity.

The illustrated example ticket vending machine 100 includes: (a) a machine housing 110 including a front door 200; (b) three ticket drawer holders 300a, 300b, and 300c positioned in and supported by the machine housing 110; and (c) three separate and independently movable ticket bursters 400a, 400b, and 400c positioned in the machine housing 110 and supported by burster supports (not labeled) positioned in and supported by the machine housing 110; and (d) a controller 500. The front door 200 includes a ticket collection receptacle 250 configured to receive separated lottery tickets from each of the ticket bursters 400a, 400b, and 400c. The quantity, positions, sizes, and configurations of the ticket drawer holders and the ticket bursters can vary in accordance with the present disclosure. In various embodiments, a front door of the ticket vending machine includes one or more ticket display windows that provide improved visibility of the ticket drawer holders 300a, 300b, and 300c and the ticket bursters 400a, 400b, and 400c. It should be appreciated that this example ticket vending machine is just one example that the present disclosure can be employed in, and that the present disclosure can be employed with other vending machines that have different ticket drawer and ticket burster configurations.

It should be appreciated that the ticket vending machine 100 includes various other components that are conventional in the industry and/or that would be readily apparent to those of ordinary skill in the art. For example, the ticket vending machine 100 can include: (1) various electronic components (not shown) some of which can be contained in an electronic component holder (not labeled) positioned in and supported by the machine housing 110; and (2) various purchaser interface components 210 that are part of the front door 200 of the machine housing 110. These components are only briefly described herein for brevity. Such electronic components can be arranged in any suitable manner. The electronic component holder can be in the form of a slide-out drawer to facilitate access to the various electronic components contained therein. The electronic components can form part of the control system for the ticket vending machine 100. Various electronic components can also be positioned in the machine housing 110 outside of the electrical component holder. The electronic components can include one or more controllers that control the operation of the ticket vending machine 100 including the movable ticket bursters 400a, 400b, and 400c as further discussed herein to facilitate the dispensing of each requested lottery ticket and the determination of any position issues of the lottery tickets (such as further described below). The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the ticket vending machine 100. The purchaser interface components 210 include one or more display devices, one or more user input devices (e.g., buttons, keypads), and one or more payment acceptors. In various embodiments, the purchaser interface components 210 include a touch-screen display 215. The purchaser interface components 210 enable purchasers to use such components to determine the lottery tickets available from the ticket vending machine 100, and to select and pay for any of those lottery tickets held by the ticket vending machine 100 that the purchaser desires to obtain. The purchaser interface components 210 can display images and information to inform purchasers of the different lottery tickets available from the ticket vending machine 100 and to assist in completing the selection and purchase of such lottery tickets. These electronic components and purchaser interface components 210 can take many different forms as well known in the industry, and are thus not described in detail herein for brevity.

In various embodiments described herein, the purchaser interface components 210 include a code reader 220, such as a barcode reader, a two dimensional code reader, a quick response (QR) code reader, an image capture device, or other suitable input device (such as but not limited to an electronic signal receiver). The code reader 220 is configured to receive an input code, such as a printed code, a displayed code, or an electronic code. The printed code can be printed on a physical media, such as a lottery ticket, identification card, identification badge, or other suitable physical media. The displayed code can be displayed on a display device of a smartphone, tablet, smart watch, or other suitable device. The electronic code can be in a suitable format such that it is obtained wirelessly (such as via Bluetooth, NFC, or other suitable communication systems). For purposes of the present disclosure, scanning the displayed code is used as an example, but that is not meant to limit the present disclosure.

In various embodiments, the code reader 220 enables a technician to access a maintenance menu of the lottery ticket vending machine 100 by scanning a maintenance access code, as described herein. In various embodiments, the code reader 220 enables a user to redeem a winning instant lottery ticket by scanning a bar code on that ticket. In various embodiments, the code reader 220 enables a user to enter a user identifier or rewards card identifier, for example, by scanning a bar code printed on a rewards card and/or displayed on a smartphone screen.

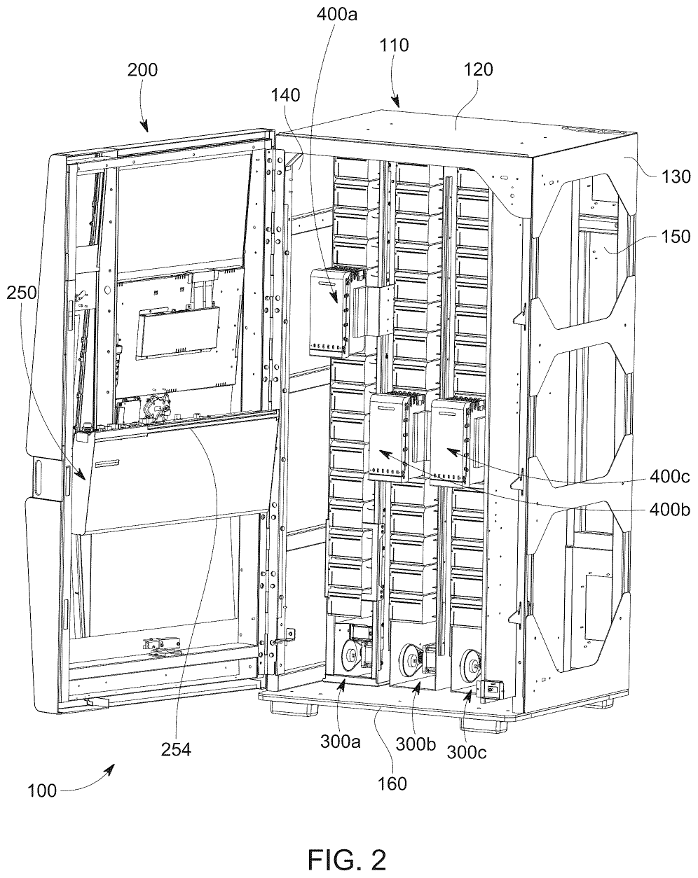

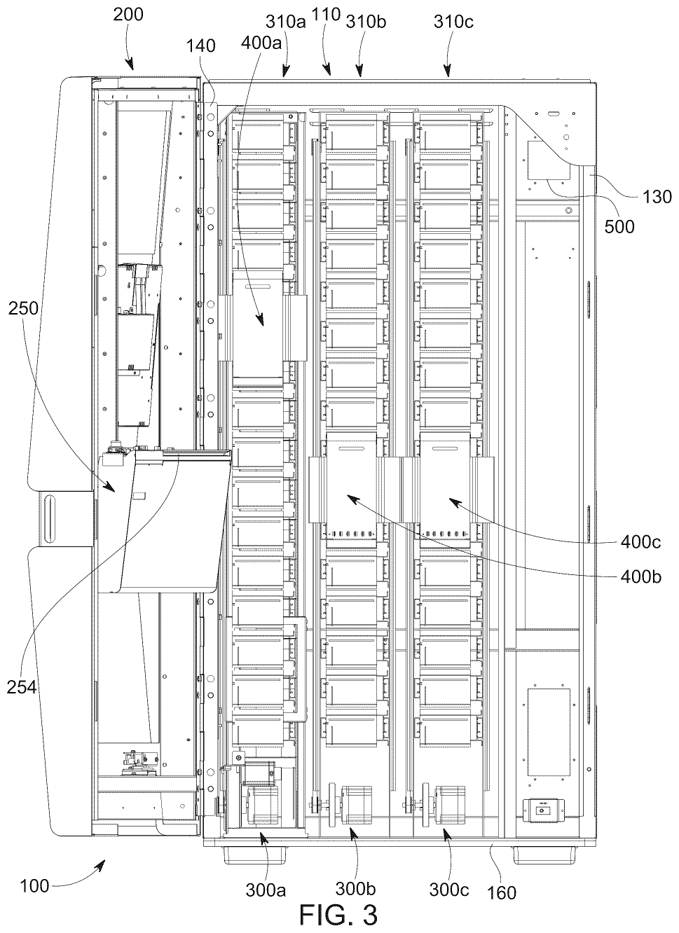

In this illustrated example embodiment, the machine housing 110 includes a top wall 120, spaced-apart side walls 130 and 140, a rear wall 150, a base 160, and the openable front door 200 pivotally connected to the side wall 140. The base 160 is configured to rest on a floor or other suitable support. The machine housing 110 includes suitable vertically extending supports (not labeled) configured to hold and support the respective ticket drawer holders 300a, 300b, and 300c. The front door 200 is moveable from a closed and locked position covering the open front face of the machine housing 110 as shown in FIG. 1 to an open position allowing access to the interior of the machine housing 110 as shown in FIGS. 2 and 3. The front door 200 is mounted by hinges (not labeled) to the side wall 140 of the machine housing 110. A suitable locking mechanism (not shown) is mounted on the front door 200 and the side wall 130 of the machine housing 110 to facilitate locking of the front door 200 in the closed position. When the front door 200 is closed and locked, the interior of the machine housing 110 is generally secured so as to be inaccessible except by an authorized person. The front door 200 can include one or more areas for any components supported by the front door and/or that are contained in and/or protected by the structure of the front door 200. The front door 200 can include one or more openings such as for a glass panel that enables people to see into the machine housing 110 and for one or more of the purchaser interface components 210 (such as those described below). The size and configuration of the machine housing can vary in accordance with the present disclosure.

The ticket collection receptacle 250 of the front door 200 is configured to receive lottery tickets from each of the movable ticket bursters 400a, 400b, and 400c. In alternative vending machines, the bursters can be non-movable. The ticket collection receptacle 250 is configured to hold each lottery ticket received from the movable ticket bursters to enable the respective purchaser to retrieve the dispensed lottery ticket from the ticket collection receptacle 250. The ticket collection receptacle defines an elongated horizontally extending ticket receiving slot 254 (best seen in FIGS. 2 and 3). The ticket collection receptacle 250 and the front door define an elongated horizontally extending purchase ticket retrieval slot 278 (best seen in FIG. 1). The purchase ticket retrieval slot 278 is (and needs to be) large enough so that a purchaser can insert the purchaser's hand through the purchase ticket retrieval slot 278 to retrieve lottery tickets that are dispensed into the ticket collection receptacle 250. The ticket receiving slot 254 is (and needs to be) small enough so that a purchaser cannot insert the purchaser's hand through the ticket receiving slot 254 and thereby cannot access any of the ticket drawers of the ticket drawer holders 300a, 300b, or 300c. The position, size, and configuration of the ticket collection receptacle can vary in accordance with the present disclosure.

Each of the ticket drawer holders 300a, 300b, and 300c are identical in this example embodiment. For brevity, only ticket drawer holder 300a is described in detail herein. Likewise, the three movable ticket bursters 400a, 400b, and 400c are identical in this example embodiment. For brevity, only ticket burster 400a associated with the ticket drawer holder 300a is described herein.

Ticket drawer holder 300a includes a plurality of aligned ticket drawers 310a that are vertically stacked in the holder. Each of the ticket drawers is configured to hold one or more packs of lottery tickets such as instant lottery tickets for subsequent dispensing by the ticket vending machine 100. The ticket drawers can vary in quantity, size, and configuration depending upon the particular size of the ticket vending machine 100 and the quantity, size, and shapes of the lottery tickets that the ticket vending machine 100 can or will dispense. Each ticket drawer is configured to hold lottery tickets such as instant lottery tickets for selection by the purchasers. In various embodiments, the different ticket drawers can hold different lottery ticket packs for different lottery games, but it should be appreciated, that two or more ticket drawers can hold the same type of lottery tickets, lottery tickets for the same game, etc. In various embodiments, each of the ticket drawers is configured to feed each instant lottery ticket held by that ticket drawer into the associated ticket burster 400a when the ticket burster 400a is moved into alignment with such ticket drawer (e.g., at a respective ticket receipt position) for receipt, bursting, and dispensing of that lottery ticket. This ticket movement can be caused by an actuation lever of the burster engaging a ticket movement assembly of the ticket drawer, or in another suitable manner. Bursting of the lottery ticket is the industry term for separating a lottery ticket from a pack of lottery tickets held in a ticket drawer. In this example embodiment, the ticket drawers do not burst the lottery tickets and do not need any mechanisms for bursting the lottery tickets, but rather the moveable ticket burster 400a bursts the lottery tickets fed by the ticket drawers in the ticket drawer holder 300a into that ticket burster 400a.

As shown in FIGS. 2, 3, and 4, the movable ticket burster 400a is supported by one or more burster supporters (such as burster supporter 480a). The burster supporters can be any suitable structure(s) that support(s) the ticket burster 400a in a manner that enables the ticket burster 400a to vertically move to any of the different ticket receipt positions that are associated with and in alignment with the respective ticket drawers of the ticket drawer holder 300a. Each of the burster supporters also support the ticket burster 400a in a manner that enables the ticket burster 400a to vertically move into alignment with the ticket receptacle 250.

In various embodiments, the burster supporter 480a can be any suitable structure that supports the ticket burster 400a and enables the ticket burster 400a to move to any of the different ticket receipt positions that are associated with and in alignment with the different respective ticket drawers 310 (e.g., ticket drawers 310a of the ticket drawer holder 300a, ticket drawers 310b of the ticket drawer holder 300b, and ticket drawers 310c of the ticket drawer holder 300c), and the ticket receptacle 250 if needed. For example, the burster supporter 480a can include a suitable XY gantry that supports the ticket burster 400a and enables the ticket buster 400a to move to any of these respective ticket receipt positions. In various such embodiments, the ticket vending machine 100 includes only one ticket burster 400a that is movable to any of the respective ticket receipt positions. In various such embodiments, the ticket vending machine 100 includes one active ticket burster and one or more inactive ticket bursters that are configured for use if the active ticket burster is unavailable (e.g., inoperable due to malfunction, removed for maintenance).

The ticket vending machine 100 includes one or more actuators (not shown) that control movement of the ticket burster 400a under control of the controller of the ticket vending machine 100 and/or the controller of the ticket burster 400a. In this example, an actuator (not labeled) is mounted at the bottom of the ticket drawer holder 300a and coupled to the ticket burster 400a by suitable linkages (such as but not limited to pulleys and a drive belt (not labeled)). The actuator is configured to move the ticket burster 400a under the control of the controller(s) in the vertical (e.g., up and down) directions. The movable ticket burster 400a is thus moveable, via this actuator and linkages on the ticket burster supporters to different vertical locations including a plurality of the locations respectively associated and aligned with each of the ticket drawers of the ticket drawer holder 300a such that the ticket burster 400a is positioned to receive one or more of the lottery tickets stored in each respective ticket drawer of the ticket drawer holder 300a for obtaining and dispensing that instant lottery ticket into the ticket receptacle 400 for the purchaser as requested by the purchaser. In various embodiments, the actuators are configured to move the ticket burster 400a under the control of the controller(s) in both the vertical (e.g., up and down) directions and horizontal (e.g., left and right) directions.

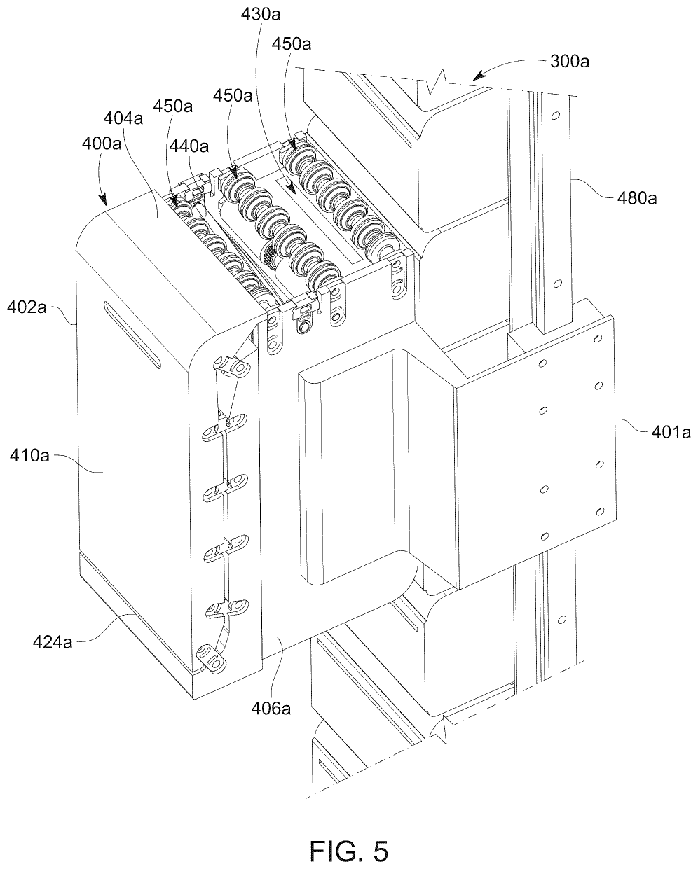

As best shown in FIGS. 5, 6, and 7, the example movable ticket burster 400a generally includes: (a) a burster housing 402a; (b) one or more burster supporter connecters (such as burster support connector 401a connecting the burster housing 402a and the burster supporter 480a); (c) a barcode reader 430a in and supported by the burster housing 402a; (d) a ticket cutter 440a in and supported by the burster housing 402a; I a plurality of ticket engagers 450a supported by the burster housing 402a; and (f) a burster controller (not shown). The size and configuration of the ticket burster can vary in accordance with the present disclosure. As indicated above, it should also be appreciated that in other embodiments, the ticket burster includes more than one barcode reader for determining barcode related data and barcode positional data. As also indicated above, it should also be appreciated that in other embodiments, the ticket burster includes one or more barcode readers for determining barcode related data, and one or more other sensors for determining barcode positional data.

More specifically, the burster housing 402a generally includes a top member 404a, spaced-apart side members (not labeled), a front member 410a, a rear member 412a, and a bottom member 414a. The burster housing 402a also includes a plurality of internal members (not individually labeled) that define a ticket inlet 422a, through which the ticket burster 400a is configured to receive a lottery ticket from a ticket drawer of the ticket drawer holder 300a, a ticket outlet 424a through which the ticket burster 400a is configured to dispense the received instant lottery ticket into the ticket collection receptacle 250, and a ticket movement path (not labeled) extending from the ticket inlet 422a to the ticket outlet 424a and through which the lottery ticket is moved through the ticket burster 400a.

The ticket cutter 440a is positioned in the burster housing 402a and configured to rotate to cut the perforations attaching each lottery ticket that moves along the ticket movement path in the ticket burster 400a to the next lottery ticket of the continuous strip of lottery tickets received from the respective ticket drawer.

In other embodiments, the ticket burster 400a can be configured such that the burster housing 402a is rotatable about a horizontal axis to separate (via a tearing and/or twisting motion) each lottery ticket along the perforations connecting that lottery ticket to the next lottery ticket in the strip. In such embodiments, the ticket drawer may not need to withdraw the next lottery ticket of the strip or may only need to withdraw the next lottery ticket of the strip a relatively small distance. In such embodiments, the ticket burster may not need a ticket cutter.

It should be appreciated that the ticket burster 400a is thus configured to burst the perforations between the lottery ticket being dispensed and the next lottery ticket of the strip so as to enable the dispensed lottery ticket to be dispensed into the ticket receptacle 250. This prevents a person from improperly tearing a lottery ticket or being able to pull an extended number of lottery tickets from one of the ticket packs in one of the ticket drawers. It should be appreciated that the ticket burster 400a can be moved to a dispensing location for each lottery ticket dispensed, or for only certain lottery tickets dispensed. It should also be appreciated that the ticket burster can moved to a different location for any lottery ticket that is deemed to be bad or non-dispensable for any reason, and to deposit that ticket into a suitable rejection area.

The ticket engagers 450a in this example embodiment include multiple driven rollers (not labeled) and multiple guide rollers (not labeled). The driven rollers are rotated by suitable actuators (not shown) under the control of the burster controller and/or the controller of the ticket vending machine 100. The driven rollers and the guide rollers are configured to move (such as by pulling) and guide each lottery ticket along the ticket movement path and out of the ticket outlet 424a. In alternative embodiments, the ticket engagers are configured to grip and pull each lottery ticket from the respective ticket drawer.

The burster controller (not shown) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) stores instructions executable by the processing device(s) to control operation of the ticket burster 400a. The burster controller can be hard wired or wirelessly connected to and in communication with the cutter 440a, the actuators for the driven rollers 450a, any actuators of the ticket burster 400a that cause the movement of the ticket burster 400a, and the reflective sensor 430a (as further described below). In such embodiments, the burster controller can be wirelessly connected to and in communication with the controller of the ticket vending machine 100. In other embodiments, the ticket burster does not include a controller and is completely controlled by the controller of the ticket vending machine 100. In such embodiments, the controller of the ticket vending machine 100 can be hard wired to or wirelessly connected to and in communication with the cutter, the actuators for the driven rollers, any actuators on the ticket burster or the burster supporter that cause the movement of the ticket burster, and the reflective sensor.

The example barcode reader 430a of the ticket burster 400a is positioned in and supported by the housing 402a of the ticket burster 400a. The barcode reader 430a extends transversely along the entire or substantially the entire width of the ticket burster 400a such that the barcode reader 430a can sense the one or more barcodes and the relative positions of the barcode(s) of each lottery ticket that moves through the ticket burster 400a as that lottery ticket moves above the barcode reader 430a. In this example embodiment, the barcode reader 430a is below the ticket movement path and thus scans upwardly toward the lottery ticket. In other alternative embodiments that are not shown, the barcode reader can be above the ticket movement path and thus scan downwardly toward the lottery ticket (which would be oriented to have the barcode facing upwardly).

The respective controller(s) receive and interpret the barcode related data in a suitable manner.

In various embodiments, the controller 500 includes a processor and a memory (not shown). The memory includes instructions that when executed by the processor cause and/or configure the processor to provide functionality as described herein. In various embodiments, the controller 500 includes a local maintenance access module (not shown) that is stored in the memory and includes the instructions. In other embodiments, all or a portion of the controller 500 can be implemented using application-specific integrated circuits or other suitable hardware.

The above described lottery ticket vending machine is one example lottery ticket vending machine that the present disclosure can be employed with. It should be appreciated that the present disclosure can be employed with other suitable lottery ticket vending machines.

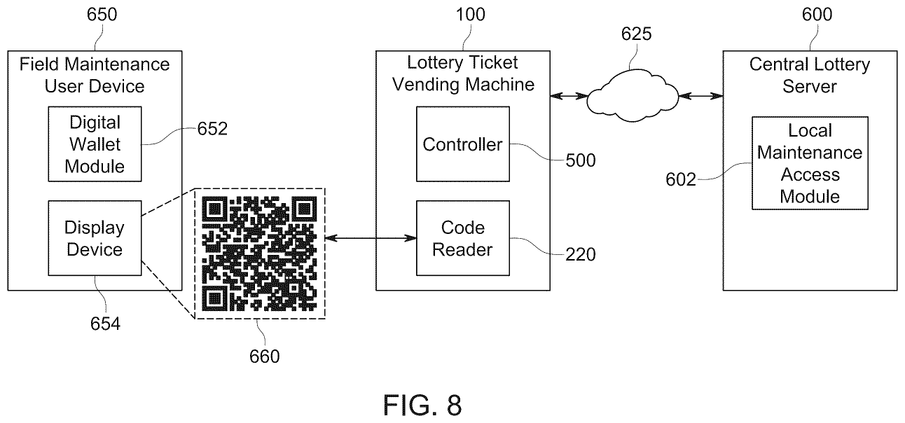

Turning to FIG. 8, a system for providing a local maintenance access feature for the lottery ticket vending machine includes the lottery ticket vending machine 100, a central lottery server 600, and a field maintenance user device 650.

As described above, the lottery ticket vending machine 100 includes the controller 500 and the code reader 220 that is configured to receive such as via scanning an input code, such as a maintenance access code as described below.

The central lottery server 600 includes a processor (not shown) and a memory (not shown). It should be appreciated that the central lottery server 600 includes various other electronic components. The electronic components can include one or more controllers that control the operation of the central lottery server 600 to facilitate operation of the lottery ticket vending machine 100. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the central lottery server 600. The central lottery server 600 can be communicatively coupled with the lottery ticket vending machine 100 by a network 625, such as a private lottery network, the Internet, or other suitable communications network.

In various embodiments, the central lottery server 600 includes one or more modules that enable functionality as described herein. In other words, the modules form part of the control system for the central lottery server 600. For example, the functionality can include authentication of local maintenance access to the lottery ticket vending machine 100. In the embodiment shown in FIG. 8, the central lottery server 600 includes a local maintenance access module 602. The local maintenance access module 602 is configured to facilitate maintenance of the lottery ticket vending machine 100, for example, by providing a maintenance access code to the field maintenance user device 650. In the embodiment shown in FIG. 8, the module is implemented as a software and/or firmware module stored within the memory and includes instructions that when executed by the processor cause and/or configure the processor to enable the functionality. In other embodiments, the module 602 and/or portions thereof can be implemented using application-specific integrated circuits or other suitable hardware. In various embodiments, the functionality also includes one or more of activation of instant lottery tickets, processing of draw game wager requests for draw lottery tickets, processing of ticket redemption requests for lottery tickets, and other lottery ticket related functionality.

This example field maintenance user device 650 is associated with a field technician, service technician, retail employee, or other suitable user (referred to herein as a “technician” for brevity). The field maintenance user device 650 includes a processor (not shown), a memory (not shown), a digital wallet module 652, and a display device 654. It should be appreciated that the field maintenance user device 650 can include various other electronic components. The electronic components can include one or more controllers that control the operation of the field maintenance user device 650. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the field maintenance user device 650. In various embodiments, the field maintenance user device 650 can be communicatively coupled with one or more remote devices, such as the central lottery server 600 and/or a third party authentication server by a suitable communications network.

In various embodiments, the field maintenance user device 650 is a smartphone, tablet, smart watch, or other suitable electronic user device. In various embodiments, the field maintenance user device 650 can be provided to a technician employed by an operator of the lottery ticket vending machine 100, for example, to enable the technician to receive work orders and to securely access a vending machine maintenance user interface of the lottery ticket vending machine 100. In other embodiments, the field maintenance user device 650 is a personal device of the technician (e.g., a personal smartphone) that is configured to communicate with the central lottery server 600, for example, by installing an application or module associated with the local maintenance access module 602. The field maintenance user device 650 includes one or more user interface devices, such as the display device 654 (e.g., an LCD, OLED, touch-screen display, or other suitable display device), input devices (e.g., buttons, bar code readers), speakers, or other suitable components.

In various embodiments, the field maintenance user device 650 includes one or more modules that enable functionality as described herein. In other words, the modules form part of the control system for the field maintenance user device 650. In the embodiment shown in FIG. 8, the field maintenance user device 650 includes the digital wallet module 652, which is configured to facilitate maintenance of the lottery ticket vending machine 100, for example, by causing a display of a maintenance access code 660 via the display device 654. In the embodiment shown in FIG. 8, the digital wallet module 652 is implemented as a software and/or firmware module stored within the memory and includes instructions that when executed by the processor cause and/or configure the processor to enable the functionality. In other embodiments, the module 652 and/or portions thereof can be implemented using application-specific integrated circuits or other suitable hardware.

In the embodiment shown in FIG. 8, the maintenance access code 660 includes a QR code that is scannable by the code reader 220 of the lottery ticket vending machine 100. In some examples, the maintenance access code 660 can include a bar code, an image, alphanumeric text, or other suitable information.

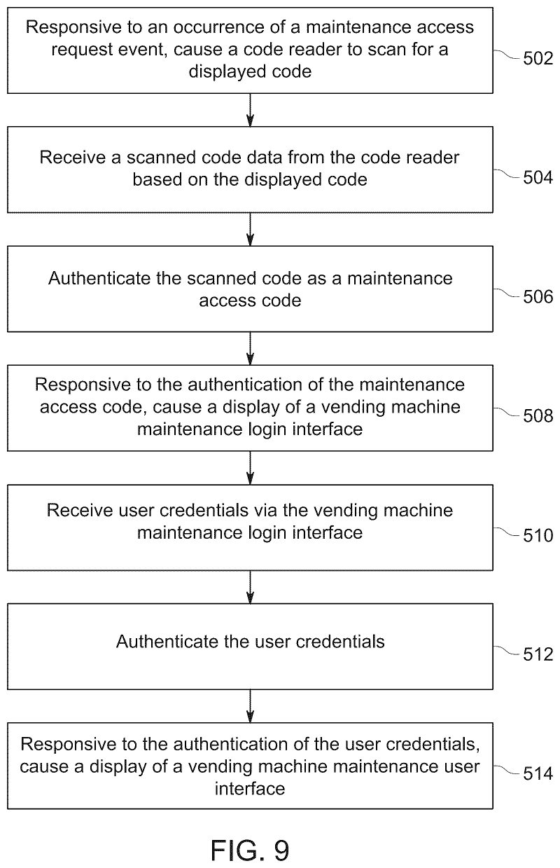

Turning to FIG. 9, an example process for providing a local maintenance access feature to the lottery ticket vending machine 100 is now described. It should be appreciated that the following example is not the only method of operation of the ticket vending machine of the present disclosure, and other methods of operation are within the scope of the present disclosure. It should also be appreciated that the operations are controlled by the controller 500 of the ticket vending machine and that the descriptions provided below of the steps are controlled by one or more of such controllers.

This example is when a technician wishes to view and/or interact with the vending machine maintenance user interface of the lottery ticket vending machine 100. Responsive to an occurrence of a maintenance access request event, the controller 500 authenticates the technician, including receiving such as via scanning for a maintenance access code. After authentication, the controller 500 causes the purchaser interface components 210 to provide the vending machine maintenance user interface.

More specifically, responsive to an occurrence of a maintenance access request event, the controller 500 causes the code reader 220 to scan a displayed code, as indicated at block 502.

In this example, the controller 500 causes the code reader 220 to scan a displayed code that is present within a scan region of the code reader 220. In other examples, the code can be received by the code reader 220 in another suitable manner.

In various embodiments, the maintenance access request event can include an occurrence of: (1) the turning a housing access key associated with the lottery ticket vending machine 100 to a maintenance position; (2) the pressing a secret sequence of inputs (known to the technician) using the purchaser interface components 210; (3) the pressing and holding a combination of input buttons; (4) the touching a sequence of user interface buttons on the touch-screen display 215; (5) the pressing and holding portion(s) of the touch-screen display 215; or (6) other suitable maintenance interactions with the purchaser interface components 210.

The controller 500 receives scanned code data from the code reader based on the displayed code, as indicated at block 504. For purposes of the present disclosure, the term scanned code refers to code received by scanning or in any other suitable manner such as described herein. For purposes of the present disclosure, the term scanned code data refers to the data that results from the scanning or other receipt of the code in another suitable manner such as described herein. This scanned code data can also be referred to as code data ore received code data herein.

For example, the code reader 220 scans the displayed code and provides the scanned code data to the controller 500. In various scenarios, the scanned code data can be associated with the maintenance access code 660, a bar code on an instant lottery ticket, a quick response (QR) code on an instant lottery ticket, or another non-maintenance access code. In this example, a technician employed by an operator of the lottery ticket vending machine 100 accesses the field maintenance user device 650 (e.g., with a passcode or biometric identifier) and activates the digital wallet module 652 to cause the maintenance access code 660 to be displayed on the display device 654 of the field maintenance user device 650. The code reader 220 scans the maintenance access code 660 and provides scanned code data based on the maintenance access code 660 to the controller 500.

The controller 500 authenticates the scanned code data as a maintenance access code, as indicated at block 506.

As indicated above, in some scenarios the scanned code data can be associated with a non-maintenance access code. In various embodiments, the controller 500 compares the scanned code data to an authorized code stored in the memory of the controller 500 (or other suitable memory) and authenticates the scanned code data when it matches the authorized code. In other embodiments, the controller 500 sends an authorization request to the local maintenance access module 602. The authorization request can be based on and/or include the scanned code data, enabling the local maintenance access module 602 to authenticate the scanned code data and provide a suitable authorization response when an authorized code is matched and a refusal response when the authorized code is not matched.

Responsive to authentication of the scanned code data, the controller 500 causes a display of a vending machine maintenance login interface (not shown), as indicated at block 508. The controller 500 causes the touch-screen display 215 to display the vending machine maintenance login interface. In various embodiments, the vending machine maintenance login interface provides a prompt to the technician enabling the technician to enter user credentials, such as a user name and password, or other suitable login challenge.

The controller 500 receives user credentials via the vending machine maintenance login interface, as indicated at block 510. For example, the technician can enter a user name and password as the user credentials via the vending machine maintenance login interface.

The controller 500 authenticates the user credentials, as indicated at block 512. In various embodiments, the controller 500 compares the user credentials to authorized credentials stored in the memory of the controller 500 (or other suitable memory) and authenticates the user credentials when they match the authorized credentials. In other embodiments, the controller 500 sends an authorization request to the local maintenance access module 602. The authorization request can be based on and/or include the user credentials, enabling the local maintenance access module 602 to authenticate the user credentials and provide a suitable authorization response when authorized credentials are matched.

Responsive to authorization of the user credentials, the controller 500 causes a display of a vending machine maintenance user interface (not shown), as indicated at block 514. In various embodiments, the vending machine maintenance user interface enables one or more of diagnostic actions, maintenance actions, operational report generation, or other suitable actions associated with field maintenance of the lottery ticket vending machine 100.

In various embodiments, by requiring the maintenance access code to be authenticated before displaying the login interface, the controller 500 prevents unauthorized attempts to log in to the vending machine maintenance user interface. That is, the controller 500 prevents brute force attempts to access the vending machine maintenance user interface by a malicious actor or unauthorized user because even the entry of user credentials is restricted to users with a valid maintenance access code. The controller 500 also prevents legitimate lottery ticket purchasers from accidentally accessing the login interface.

In various embodiments, the controller 500 enables the secure use of the purchaser interface components 210 for maintenance actions, instead of or in addition to using a separate display device (not shown) for maintenance actions. The separate display device can be located inside the machine housing 110, requiring a housing access key, opening the front door 200, etc. In various embodiments, the separate display device can be omitted from the lottery ticket vending machine 100, reducing complexity of the lottery ticket vending machine 100. In various embodiments, the secure use of the purchaser interface components 210 for maintenance actions enables additional maintenance actions that are otherwise unavailable when opening the front door 200 to access the separate display device. For example, certain components of the lottery ticket vending machine 100 may be disabled when the front door 200 is opened, such as disconnecting electrical power to the ticket bursters to prevent accidental injury to the technician from their operation. By enabling the use of the purchaser interface components 210 for maintenance actions, the front door 200 need not be opened, electrical power can be maintained to the ticket bursters, and diagnostic or maintenance actions that require electrical power to the ticket bursters can be performed.

Although the above described example is for a technician, in various embodiments the controller 500 enables access to other users, such as retail store personnel in which the lottery ticket vending machine 100 is located. In some such embodiments, an electronic user device of a retail personnel is provided with a different access code instead of the maintenance access code 660. In some such embodiments, the controller 500 provides a different administrative user interface, instead of the vending machine maintenance user interface, responsive to the different access code.

In various embodiments, the controller 500 determines that the maintenance access request event has occurred upon receipt of a scanned maintenance access code from the code reader 220. In some such embodiments, the code reader 220 is configured to constantly scan within the scan region and as such, a code may or may not be present within the scan region of the code reader 220. In other such embodiments, the code reader 220 is configured to periodically scan, such as scanning every second, every three seconds, or with another suitable scanning interval. In various scenarios, a code may not be present within a scan region of the code reader 220 or may not be readable by the code reader 220. In some such scenarios, the code reader 220 can provide an error message to the controller 500 that indicates a failure to read a code and prevents verification. In other such scenarios, the code reader 220 does not provide an error message to the controller 500.

In various embodiments, the controller 500 determines that the maintenance access request event has occurred upon receipt of a message from the central lottery server 600. For example, the central lottery server 600, via the local maintenance access module 602, can transmit a local maintenance access authorization message to the lottery ticket vending machine 100 to enable the local maintenance access feature of the controller 500 and cause the code reader 220 to scan the displayed code. In some such embodiments, the technician can cause a request for the local maintenance access authorization message to be sent to the local maintenance access module 602, for example, by interacting with the digital wallet module 652 to send the request. In some such embodiments, the local maintenance access module 602 sends the authorization message at a selected time, such as a periodic maintenance interval when the technician typically services the lottery ticket vending machine 100, responsive to a service call, or another suitable time. In various embodiments, the authorization message provides an additional layer of security by preventing a malicious user from attempting to display an illegitimate copy of the maintenance access code 660 (e.g., an unauthorized image taken over the technician's shoulder) because the code reader 220 does not attempt to scan the illegitimate copy (or alternatively, the controller 500 ignores scanned code data when no authorization message has been received).

In various embodiments, the controller 500 uses a first operational mode and a second maintenance mode based on the maintenance access request event. In the first operational mode, the controller 500 limits processing of scanned code data to processing associated with lottery tickets, such as scanning bar codes for redemption of lottery tickets, purchase of lottery tickets, etc. In the second operational mode, the controller 500 limits processing of scanned code data to authentication of the maintenance access code, as described above. In various embodiments, the controller 500 causes the touch-screen display 215 to selectively display a lottery ticket purchase user interface (e.g., during the first operational mode) and the vending machine maintenance user interface (e.g., after authentication of the maintenance access code).

In various embodiments, the maintenance access code 660 includes a changeable or rolling code that is changed responsive to an occurrence of a code update event. That is, a current, first maintenance access code is valid for a first period of time, a second, different maintenance access code is valid for a second period of time after the first period, etc. In such embodiments, the digital wallet module 652, the controller 500, and/or the local maintenance access module 602 are synchronized so that the field maintenance user device 650 displays a current maintenance access code that matches a current authorized code determined by the controller 500 and/or local maintenance access module 602. In various embodiments, the code update event occurs based on a predetermined security time interval for improved security, such as every 60 seconds, 24 hours, or other suitable time interval. In various embodiments, the code update event occurs responsive to a code update instruction received from the local maintenance access module 602.

In various embodiments, the lottery ticket vending machine 100 is configured to receive the current maintenance access code from the central lottery server 600 such as, for example, within a local maintenance access authorization message. In various embodiments, the controller 500 selects the current maintenance access code 660 from among a plurality of authorized codes. In various such embodiments, the lottery ticket vending machine 100 stores the plurality of authorized codes. In various embodiments, the maintenance access code 660 includes a dynamic code that is generated and/or calculated such as, for example, based on a hash function or other suitable function. In various embodiments, the dynamic code is generated by the local maintenance access module 602 of the central lottery server 600, by the controller 500, or another suitable entity.

In various embodiments, the maintenance access code 660 enables a two-factor authentication for access to the vending machine maintenance user interface. In various embodiments, the digital wallet module 652 includes a third party authenticator application (such as but not limited to Google Authenticator or Microsoft Authenticator). In various such embodiments, communications between the field maintenance user device 650 and the central lottery server 600 are omitted and the central lottery server 600 is not needed within the system shown in FIG. 8.

In various embodiments, the lottery ticket vending machine 100 includes, or is communicatively coupled with an image capture device, such as a security camera or anti-tampering camera. In various such embodiments, the controller 500 is configured to receive image capture data associated with the image capture device and the maintenance access code 660 can be held in front of the image capture device alternatively, or in addition to, the code reader 220. That is, the controller 500 can use the image capture device as a code reader and process image capture data received from the image capture device as the scanned code data described above.

In various embodiments, the controller 500 omits the steps of blocks 508, 510, and 512 described above and instead provides the vending machine maintenance user interface after verification of the maintenance access code 660.

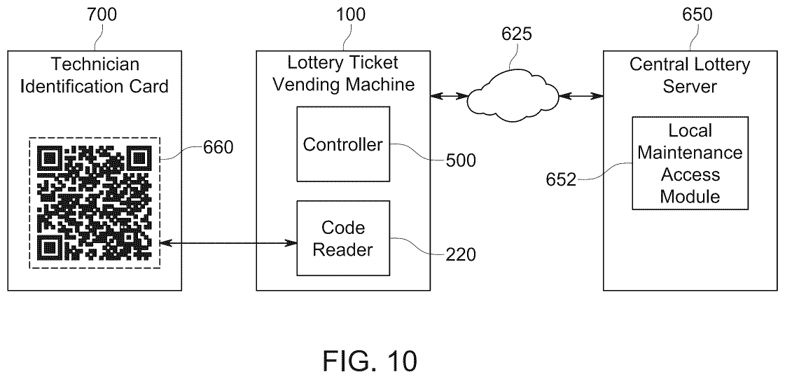

Turning to FIG. 10, a system for providing local maintenance access feature according to an alternative embodiment of the present disclosure is shown. The system includes the lottery ticket vending machine 100 and the central lottery server 600 that are communicatively connected via the network 625. The system also includes a technician identification card 700 that identifies a technician who is authorized to perform maintenance on the lottery ticket vending machine 100.

The technician identification card 700 includes the maintenance access code 660, described above, as a printed code. In various embodiments, the technician identification card 700 is an identification badge or other suitable identification card that identifies the technician. The technician can enable the vending machine to scan the maintenance access code 660 from their identification badge to gain access to the vending machine maintenance user interface using the process described above.

It should be appreciated that the local maintenance access feature can be employed in other suitable lottery ticket vending machines, which can operate in different suitable manners.

It should be appreciated from the above that various embodiments of the present disclosure provide a lottery ticket vending machine comprising: (1) a housing; (2) a ticket drawer holder in the housing, the ticket drawer holder comprising a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a code reader supported by the housing, the code reader configured to receive an input code; (5) a display device supported by the housing; and (6) a controller comprising a processor and memory device that stores a plurality of instructions, which when executed by the processor cause the processor to: (a) cause the code reader to receive an input code; (b) receive code data that is based on the input code received by the code reader; (c) authenticate the code data as a maintenance access code; and (d) responsive to authentication of the code data, cause a display by the display device of a vending machine maintenance user interface. In various such embodiments, the plurality of instructions, when executed by the processor, cause the processor to cause the code reader to receive the input code responsive to an occurrence of a maintenance access request event. In various such embodiments, the lottery ticket vending machine includes purchaser interface components that enable the lottery ticket purchaser to select and purchase the lottery ticket, and wherein the maintenance access request event comprises a maintenance interaction with the purchaser interface components. In various such embodiments, the maintenance access request event comprises a receipt of a local maintenance access authorization message from a central lottery server associated with the lottery ticket vending machine. In various such embodiments, the plurality of instructions, when executed by the processor, cause the processor to selectively cause the display device to display a lottery ticket purchase user interface and the vending machine maintenance user interface. In various such embodiments, the plurality of instructions, when executed by the processor, cause the processor to: cause the display device to display the lottery ticket purchase user interface during a first operational mode of the controller; and cause the display device to display the vending machine maintenance user interface during a second maintenance mode of the controller. In various such embodiments, the plurality of instructions, when executed by the processor, cause the processor to cause the controller to enter the second maintenance mode responsive to an occurrence of a maintenance access request event. In various such embodiments, the input code comprises a displayed code on a display device of an electronic user device. In various such embodiments, the maintenance access code comprises a rolling code. In various such embodiments, the input code comprises a printed code on a technician identification card. In various such embodiments, the code reader comprises a security image capture device and the code data comprises image capture data captured by the security image capture device.

It should further be appreciated from the above that various embodiments of the present disclosure provide a lottery ticket vending machine comprising: (1) a housing; (2) a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a code reader supported by the housing, the code reader configured to receive an input code; (5) a display device supported by the housing; and (6) a controller comprising a processor and memory device that stores a plurality of instructions, which when executed by the processor cause the processor to: (a) cause the code reader to receive an input code displayed by a display device of a field maintenance user device, wherein the input code comprises a changeable code; (b) receive code data that is based on the input code received by the code reader; (c) authenticate the code data as a maintenance access code; and (d) responsive to authentication of the code data, cause a display by the display device of a vending machine maintenance user interface. In various such embodiments, the plurality of instructions, when executed by the processor, cause the processor to compare the code data with an authorized code that is changeable over time and to authenticate the code data as the maintenance access code responsive to the code data matching a current authorized code. In various such embodiments, the plurality of instructions, when executed by the processor, cause the processor to select a different authorized code from a plurality of stored codes responsive to an occurrence of a code update event. In various such embodiments, the code update event occurs based on a predetermined security interval. In various such embodiments, the display device comprises a touch-screen display that enables the lottery ticket purchaser to select and purchase the lottery ticket.

It should further be appreciated from the above that various embodiments of the present disclosure provide a lottery ticket vending machine comprising: (1) a housing; (2) a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a code reader supported by the housing, the code reader configured to receive an input code; (5) a display device supported by the housing; and (6) a controller comprising a processor and memory device that stores a plurality of instructions, which when executed by the processor cause the processor to: (a) cause the code reader to receive an input code; (b) receive code data that is based on the input code received by the code reader; (c) authenticate the code data as a maintenance access code based on a local maintenance access authorization message received from a central lottery server; and (d) responsive to authentication of the code data, cause a display by the display device of a vending machine maintenance user interface. In various such embodiments, the local maintenance access authorization message comprises an authorized code and the plurality of instructions, when executed by the processor, cause the processor to compare the code data with the authorized code and to authenticate the code data as the maintenance access code responsive to the code data matching the authorized code. In various such embodiments, the local maintenance access authorization message comprises an authorization confirmation that the code data matches an authorized code. In various such embodiments, the plurality of instructions, when executed by the processor, cause the processor to send an authorization request to the central lottery server based on the code data for authentication of the code data by the central lottery server; and wherein the local maintenance access authorization message comprises an authorization response to the authorization request.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery ticket vending machine comprising:
a housing;
a ticket drawer holder in the housing, the ticket drawer holder comprising a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a code reader supported by the housing, the code reader configured to receive an input code;
a display device supported by the housing; and
a controller comprising a processor and memory device that stores a plurality of instructions, which when executed by the processor cause the processor to:
cause the code reader to receive an input code;
receive code data that is based on the input code received by the code reader;
authenticate the code data as a maintenance access code; and
responsive to authentication of the code data, cause a display by the display device of a vending machine maintenance user interface.

2. The lottery ticket vending machine of claim 1, wherein the plurality of instructions, when executed by the processor, cause the processor to cause the code reader to receive the input code responsive to an occurrence of a maintenance access request event.

3. The lottery ticket vending machine of claim 2, which comprises purchaser interface components that enable the lottery ticket purchaser to select and purchase the lottery ticket, and wherein the maintenance access request event comprises a maintenance interaction with the purchaser interface components.

4. The lottery ticket vending machine of claim 2, wherein the maintenance access request event comprises a receipt of a local maintenance access authorization message from a central lottery server associated with the lottery ticket vending machine.

5. The lottery ticket vending machine of claim 1, wherein the plurality of instructions, when executed by the processor, cause the processor to selectively cause the display device to display a lottery ticket purchase user interface and the vending machine maintenance user interface.

6. The lottery ticket vending machine of claim 5, wherein the plurality of instructions, when executed by the processor, cause the processor to:
cause the display device to display the lottery ticket purchase user interface during a first operational mode of the controller; and
cause the display device to display the vending machine maintenance user interface during a second maintenance mode of the controller.

7. The lottery ticket vending machine of claim 6, wherein the plurality of instructions, when executed by the processor, cause the processor to cause the controller to enter the second maintenance mode responsive to an occurrence of a maintenance access request event.

8. The lottery ticket vending machine of claim 1, wherein the input code comprises a displayed code on a display device of an electronic user device.

9. The lottery ticket vending machine of claim 1, wherein the maintenance access code comprises a rolling code.

10. The lottery ticket vending machine of claim 1, wherein the input code comprises a printed code on a technician identification card.

11. The lottery ticket vending machine of claim 1, wherein the code reader comprises a security image capture device and the code data comprises image capture data captured by the security image capture device.

12. A lottery ticket vending machine comprising:
a housing;
a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a code reader supported by the housing, the code reader configured to receive an input code;
a display device supported by the housing; and
a controller comprising a processor and memory device that stores a plurality of instructions, which when executed by the processor cause the processor to:
cause the code reader to receive an input code displayed by a display device of a field maintenance user device, wherein the input code comprises a changeable code;
receive code data that is based on the input code received by the code reader;
authenticate the code data as a maintenance access code; and
responsive to authentication of the code data, cause a display by the display device of a vending machine maintenance user interface.

13. The lottery ticket vending machine of claim 12, wherein the plurality of instructions, when executed by the processor, cause the processor to compare the code data with an authorized code that is changeable over time and to authenticate the code data as the maintenance access code responsive to the code data matching a current authorized code.

14. The lottery ticket vending machine of claim 13, wherein the plurality of instructions, when executed by the processor, cause the processor to select a different authorized code from a plurality of stored codes responsive to an occurrence of a code update event.

15. The lottery ticket vending machine of claim 14, wherein the code update event occurs based on a predetermined security interval.

16. The lottery ticket vending machine of claim 12, wherein the display device comprises a touch-screen display that enables the lottery ticket purchaser to select and purchase the lottery ticket.

17. A lottery ticket vending machine, comprising:
a housing;
a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a code reader supported by the housing, the code reader configured to receive an input code;
a display device supported by the housing; and
a controller comprising a processor and memory device that stores a plurality of instructions, which when executed by the processor cause the processor to:
cause the code reader to receive an input code;
receive code data that is based on the input code received by the code reader;
authenticate the code data as a maintenance access code based on a local maintenance access authorization message received from a central lottery server; and
responsive to authentication of the code data, cause a display by the display device of a vending machine maintenance user interface.

18. The lottery ticket vending machine of claim 17, wherein the local maintenance access authorization message comprises an authorized code and the plurality of instructions, when executed by the processor, cause the processor to compare the code data with the authorized code and to authenticate the code data as the maintenance access code responsive to the code data matching the authorized code.

19. The lottery ticket vending machine of claim 17, wherein the local maintenance access authorization message comprises an authorization confirmation that the code data matches an authorized code.

20. The lottery ticket vending machine of claim 19, wherein the plurality of instructions, when executed by the processor, cause the processor to send an authorization request to the central lottery server based on the code data for authentication of the code data by the central lottery server; and wherein the local maintenance access authorization message comprises an authorization response to the authorization request.
